(19) United States
(12) Patent Application Publication
(10) Pub. No.: US 2022/0046952 A1
(43) Pub. Date: Feb. 17, 2022

(54) PRODUCTION METHOD FOR BONE BROTH

(71) Applicant: Ajinomoto Health & Nutrition North America Inc., Itasca, IL (US)

(72) Inventors: Tomohiro Kodera, Itasca, IL (US); Kyle Kuta, Itasca, IL (US)

(73) Assignee: Ajinomoto Health & Nutrition North America Inc., Itasca, IL (US)

(21) Appl. No.: 17/400,437

(22) Filed: Aug. 12, 2021

Related U.S. Application Data
(60) Provisional application No. 62/706,359, filed on Aug. 12, 2020.

(51) Int. Cl. A23J 3/34; A23J 1/10; A23L 23/00

(52) U.S. Cl. CPC A23J 3/341; A23V 2002/00; A23L 23/00; A23J 1/10

(57) ABSTRACT

A process for producing a bone extract for food use which includes viscosity reduction of a raw material extract using a protease prior to its concentration.

### CROSS-REFERENCE TO RELATED APPLICATIONS

This application claims priority to U.S. Provisional Patent Application Ser. No. 62/706,359, filed on Aug. 12, 2020, which is incorporated by reference in its entirety.

### BACKGROUND

In the preparation of many food products, such as soups, stews, broths, and the like, it is the customary practice to add meat flavoring to the preparation. Such flavoring may be in addition to any meat in the product. One method commonly practiced to obtain such meat flavoring is to cook bones remaining after butchering in commercial meat packing. Usually, this method has been accomplished on a batch basis, has been relatively expensive and slow, has produced a relatively low yield of broth or stock, and the flavoring produced has lacked uniformity and quality.

In the case of extracts for food use which are broadly used in processed food, such as livestock meat extracts, poultry extracts, fish extracts, and the like, they are concentrated after their extraction from raw materials.

Prior art bone extracts, however, are in the form of hard gel even at ordinary temperature and have no fluidity. In view of above, it is an object of the present invention to establish a process for the production of bone broth wherein the viscosity can be lowered in a pre-concentration step.

### BRIEF DESCRIPTION

Various details of the present disclosure are hereinafter summarized to provide a basic understanding. This summary is not an extensive overview of the disclosure and is neither intended to identify certain elements of the disclosure, nor to delineate scope thereof. Rather, the primary purpose of this summary is to present some concepts of the disclosure in a simplified form prior to the more detailed description that is presented hereinafter.

In one illustrative embodiment, a method for producing bone broth which comprises use of at least one protease from Bacillus species wherein a reaction condition is at least 150° F. is provided. The relative activity of the at least one protease from Bacillus at 120° F. is more than 75%. In this regard, the protease is thermostable.

In another embodiment, a method for producing a highly concentrated fluid extract for food use from a protein containing fluid extract of bones of domestic animals or poultry is provided. The process comprises subjecting the bone extract to a step of treatment with at least one protease from Bacillus species at a temperature of at least 150° F., and thereafter subjecting the viscosity reduced extract to the step of concentrating the treated bone extract. The viscosity reducing treatment is sufficient to reduce the viscosity to 10,000 cp or less, or sufficient to reduce the viscosity to at least 55% comparing before the treatment when measured by a Brookfield type rotary viscometer at 50° F. for one minute at 50 rpm when the Brix is about 45. In one embodiment, the viscosity reducing treatment does not generate serious bitterness and browning.

### DETAILED DESCRIPTION

A more complete understanding of the components, processes and apparatuses disclosed herein can be obtained by reference to the accompanying drawing. The figure is merely a schematic representation based on convenience and the ease of demonstrating the present disclosure, and is, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure.

The singular forms “a,” “an,” and “the” include plural referents unless the context clearly dictates otherwise.

As used herein, the terms about, generally and substantially are intended to encompass structural or numerical modifications which do not significantly affect the purpose of the element or number modified by such term.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

Disclosed herein is a method for the production of bone broth for food use of the present invention, any of the prior art food extract production processes including raw materials to be extracted can be employed with no particular limitation, except for the viscosity reducing treatment, which is a feature of the present invention. As it is known in the art, raw materials as the extraction source of livestock meat extracts include bones, waste flesh, internal organs and the like of cattle, swine, horse, sheep, goat, deer and the like domestic animals, those of poultry extracts include bones, waste flesh, internal organs and the like of domestic fowl, ducks, geese, turkeys and the like poultry, those of fish extracts include oysters, crabs, scallops and the like. Extraction of these raw materials to be extracted is also carried out in the usual way using appropriate extraction solvents or not particularly using extraction solvents, and the resulting extracts are optionally subjected to purification, concentration and the like treatments to obtain highly concentrated extract products for food use.

The following will be focused on the viscosity reducing treatment.

In the process of the present invention, each raw material is firstly subjected to an extraction treatment to obtain an extract. This step is not different from that as in the usual extract production method. Optionally, a separation step may occur next.

Next, the thus obtained extract is subjected to the viscosity reducing treatment of the present invention before the concentration step.

Bones (raw) are combined together with water and placed into extraction equipment (e.g., cooker) and heated at an extraction temperature, e.g., to between 150° F. to about 250° F. for an appropriate amount of time, as known to one of ordinary skill in the art. The result is a raw extract (“RE”). The RE is then heated to at least 150° F. Next, at least one enzyme, e.g., protease enzyme, is added, after the RE is placed in the cooker. The mixture is heated to at least 150° F. The RE and protease mixture is kept under optimum temperature (at least 150° F.), time (e.g., 15 minutes to 1 hour) and the like conditions for the protease reaction, as further described below. The resultant mixture with reduced viscosity is next optionally separated.

The raw material extract after completion of the viscosity reducing treatment and optional separation is then optionally concentrated to obtain a highly concentrated extract product for food use. The concentration step can be completed by one of ordinary skill in the art via routine known methods.

In relation to the above “steps” it should be noted that various ones of these steps or aspects thereof can be combined or eliminated. Moreover, various ones of the steps may be performed at different times or sequentially, in different orders, or they may be performed simultaneously.

Since protein is the main component which causes viscosity when such extracts are concentrated, the protease to be used in the protease treatment of the present invention is a protein hydrolyzing enzyme for food use which is not particularly limited. As a matter of course, the protein hydrolyzing enzyme may be in the form of an enzyme preparation which contains a proteolytic enzyme, or protease, as an enzyme active component. Examples of commercially available proteases derived from Bacillus species for food use that could be used in the present invention include “Protin SD-AY10” and “Protin SD-NY10” manufactured by Amano Enzyme. Protin SD-AY10 is a bacterial neutral protease preparation derived from Bacillus lichenformis. Protin SD-NY10 is a bacterial neutral protease preparation derived from Bacillus amyloliquefaciens. Other examples of thermostable endo proteases derived from Bacillus species that could be used in the present invention include Soluzyme HA 1000, and Soluzyme HT 100. Soluzyme HA 1000 is a non-GMO, food grade alkaline protease. Soluzyme HT 100 is a non-GMO, food grade bacterial neutral protease. In this regard, thermostable endo proteases could be further defined to mean proteases that have a relative activity at 120° F. of at least about 75%. Other proteases tested in the experiments that follow include ProteAX derived from Aspergillus oryzae, Thermoase PC 10F derived from Geobacillus stearothermophilus, and Papain Sea-B-Zyme P200 derived from Papaya plant.

In the protease treatment, an extract from a raw material is treated with a protease under such conditions to decrease the viscosity. In particular, the protease is added to the extract and the mixture is kept under optimum temperature, time and the like conditions for the protease reaction. The raw material extract after completion of the viscosity reducing treatment is then optionally concentrated to obtain a highly concentrated extract product for food use. The concentration step can be completed by one of ordinary skill in the art via routine known methods. The product obtained by concentrating to such a degree still has fluidity and can be used as one of ordinary skill would desire.

For example, the measure of the fluidity that is useful would be 1,000 Cp or less, or 500 Cp or less, or 200 Cp or less, or 100 Cp or less, as measured by a Brookfield type rotary viscometer (model LVDVE, spindle used is S63, speed is 50 rpm and temperature is room temperature, about 72° F.). The measurement can be carried out at about 72° F. for about one minute at about 50 rpm and wherein the Brix degree is about 45. In this regard, compared to the viscosity of the control after heat treatment, the use of at least one protease reduces the viscosity of the bone broth by about at least 45%. In some embodiments the viscosity is reduced by at least 50%, at least 55%, at least 60%, at least 65%, at least 70%, at least 75%, at least 80%, at least 85%, at least 90%, or at least 95%, as one of ordinary skill in the art would appreciate. In one embodiment, the bone broth obtained after viscosity reduction as discussed above, there is no generation of bitterness or browning of the bone broth. In addition, compared to the viscosity of the control before heat treatment, the use of at least one protease reduces the viscosity of the bone broth by at least 80%, at least 82%, at least 84%, at least 86%, at least 88%, at least 90% or at least 92%.

One embodiment of the viscosity reducing treatment step is disclosed wherein at least one protease solution is used to reduce the viscosity of the raw extract (“RE”). First, prepare the protease solutions and hold them at 55° F. for 0 hours to 5 hours. Next, collect RE and heat to a specific reaction temperature. The reaction temperature could be at least 150° F., or at least 160° F. or at least 170° F. In prior art processes such as the one disclosed in U.S. Pat. No. 5,939,111, which is incorporated by reference in its entirety, it was disclosed that a step of using an enzyme to reduce viscosity would take place at a reaction temperature of 50° C. to 55° C. (about 122° F. to about 131° F.). However, when the current embodiment is performed at the temperature of about 130° F., the sensory aspect was determined to be not acceptable. It was surprisingly discovered that if you performed the reaction temperature at 150° F. or higher, the end product of this viscosity treatment step is an improved viscosity along with an acceptable sensory aspect as discussed further below. Another benefit of this invention is to prevent microbial contamination. The risk of microbial growth is minimized at more than 140° F.

Once the reaction temperature reaches at least 150° F., then add in the protease and mix. Hold the reaction temperature for about not less than 15 minutes. After the hold of the reaction temperature of about not less than 15 minutes is met, boil the mixture to deactivate the protease. For example, it was determined that one could boil the mixture at about 212° F. for about 25 minutes to deactivate the protease. In the next step, bring the bone broth to about 45 Brix. Once the bone broth is at about 45 Brix, check the viscosity at a standard room temperature of about 71° F. to about 77° F., and carry out sensory evaluation to ensure acceptability. More details are set forth in the examples below.

### EXAMPLES

The following examples are provided to further illustrate the present invention. In the first example, enzymes were screened. In the second example, enzyme dosage was optimized in bovine species. In a third example, enzymes were tested in bovine species at different temperatures. In a fourth example, enzyme dosage was optimized with regards to bovine species. In a fifth example, enzymes were tested with non-bovine stock and the results compared to a control. In a sixth example, enzyme combinations were tested in bovine species. In a seventh example, different enzymes were tested in bovine species.

### Example 1

Enzyme Screening

Pre-weigh broth (Raw Extract (RE)) (3792.9 g) into marked container. Pre-weigh all enzymes (3.21 g/gallon RE) into well marked containers. Heat broth to target temperature for specified enzyme. Add enzyme to broth and mix (do not add any to control). Hold at target temperature for 60 minutes. Then, immediately boil to deactivate enzyme (211° F. for 25 min). Continue boiling until broth is reduced to 45 Brix. Cool slightly and standardize Brix to 45.0+/−0.2. Check viscosity at a standard room temperature of about 71° F. to 77° F. (spindle 63 @ 50 rpm, Brookfield Rotational Viscometer model LVDVE) and record data. Pack into labeled cups and store refrigerated. Table 1 below shows the results of Example 1. Table 2 shows the amounts of enzyme and RE used along with temperature and time details for Example 1.

TABLE 1

| Enzyme | Temp. (F.) | Viscosity | Sensory Comments | Viscosity (%) |
|---|---|---|---|---|
| Control | 150.0 | 298 | Clean, savory and slightly sweet with rich meaty flavor. Firm | 100 |
| | | | gel refrigerated. Medium brown color. | |
| ProteAx | 150.0 | 101 | Clean and rich, but lacks the natural balance of the control. | 33.9 |
| | | | Gelled liquid refrigerated. | |
| Thermoase PC10F | 150.0 | 98 | Odd flavor. Unacceptable bitterness with some astringency. | 32.9 |
| Sea-B-Zyme P200 | 150.0 | 70 | Unacceptable lingering bitterness and high astringency. | 23.5 |
| Protin SD-AY10 | 130.0 | 26 | Very low viscosity | 8.7 |
| Protin SD-NY10 | 130.0 | 50 | Acceptable. Least amount of bitterness, flavor profile most | 16.8 |
| | | | similar to control. | |

Protin SD-AY10 is a bacterial neutral protease preparation derived from Bacillus lichenformis. Protin SD-NY10 is a bacterial neutral protease preparation derived from Bacillus amyloliquefaciens. ProteAX derived from Aspergillus oryzae. Thermoase PC 10F is derived from Geobacillus stearothermophilus. Papain Sea-B-Zyme P200 derived from Papaya plant.

TABLE 2

| Enzyme | RE grams | Enzyme grams | Temp. (F.) | Time (hours) |
|---|---|---|---|---|
| Control | 3792.9 | — | 150.0 | 1 |
| ProteAx | 3792.9 | 3.21 | 150.0 | 1 |
| Thermoase PC10F | 3792.9 | 3.21 | 150.0 | 1 |
| Sea-B-Zyme P200 | 3792.9 | 3.21 | 150.0 | 1 |
| Protin SD-AY10 | 3792.9 | 3.21 | 130.0 | 1 |
| Protin SD-NY10 | 3792.9 | 3.21 | 130.0 | 1 |

### Example 2

Enzyme Dosage Optimization

Collect 25 gallons of RE veal broth. Pre-weigh broth into marked containers. Pre-weigh all enzymes into well marked containers. Heat broth to target temperature for specified enzyme. Add enzyme to broth and mix (do not add any to control). Hold at target temp for exactly 1 hour. Then, immediately boil to deactivate enzyme (211° F. for 25 min). Continue boiling until broth is reduced to 45 Brix. Cool slightly and standardize Brix to 45.0+/−0.2. Check viscosity at a standard temperature of about 71° F. to about 77° F. (spindle 63 @ 50 rpm, Brookfield Rotational Viscometer model LVDVE) and record data, and check the product by sensory evaluation. Pack into labeled cups and store refrigerated. Table 3 shows the amounts of RE and enzyme used and Table 4 shows the results of Example 2. “@ %” describes the percentage of the viscosity of the broth after heat treatment to the viscosity of the control before heat treatment. The rightmost column shows the percentage of the viscosity of the broth to the viscosity of the control after heat treatment.

TABLE 3

| | | Enzyme | Temp. | Time |
|---|---|---|---|---|
| Enzyme | RE grams | (g/gallon RE) | (F.) | (hours) |
| Control | 3792.9 | — | 150.0 | 1 |
| Protin SD-NY10 | 3792.9 | 3.21 | 130.0 | 1 |
| Protin SD-NY10 | 3792.9 | 1.07 | 130.0 | 1 |
| Protin SD-NY10 | 3792.9 | 0.32 | 130.0 | 1 |
| Protin SD-AY10 | 3792.9 | 0.32 | 130.0 | 1 |

TABLE 4

| | Temp. | Enzyme | | | | Viscosity |
|---|---|---|---|---|---|---|
| Enzyme | (F) | (g/gallon RE) | Brix | Viscosity | Sensory | (%) |
| Control | 150.0 | — | 45.1 | 230 cp @ 9.6% | — | 100.0 |
| Protin SD-NY10 | 130.0 | 3.21 | 44.9 | 48 cp @ 2.0% | Darker than control, flavor | 20.9 |
| | | | | | acceptable | |
| Protin SD-NY10 | 130.0 | 1.07 | 45.2 | 86 cp @ 3.6% | Darker than control, flavor | 37.4 |
| | | | | | compares well to control | |
| Protin SD-NY10 | 130.0 | 0.32 | 44.9 | 127 cp @ 5.3% | Slightly darker than control, | 55.2 |
| | | | | | flavor compares well to control | |
| Protin SD-AY10 | 130.0 | 0.32 | 44.9 | 55 cp @ 2.3% | Slightly darker than control, | 23.9 |
| | | | | | flavor acceptable | |

### Example 3

Bovine Stock Tested at Various Temperatures.

Collect 25 gallons of RE veal broth. Pre-weigh broth into marked containers. Pre-weigh all enzymes into well marked containers. Heat broth to target temperature for specified enzyme. Heat quantity of RE to specific process temperature. Then dose enzyme per chart below. Hold for 1 hour. Then boil to deactivate enzyme (Set 100° C. for 25 minutes for inactivation.) and reduce RE to 45 Brix. Then check viscosity at standard temp (72° F.) and carry out sensory evaluation (1st analysis). Keep the samples at 55° C., 60° C. or 65° C. for 5 hours. Measure the viscosity, and conduct sensory evaluation again (2nd analysis) to check the remaining enzyme activity. Table 5 shows the amounts of RE and enzyme used and Table 6 shows results of Example 3.

TABLE 5

| | Enzyme | Temp. | | Time | Temp. |
|---|---|---|---|---|---|
| Enzyme | (g/gallon RE) | (F.) | RE grams | (hours) | (° C. ) |
| Control | — | 150.0 | 3792.9 | 1 | 65 |
| Protin SD-AY10 | 0.32 | 130.0 | 3792.9 | 1 | 55 |
| Protin SD-NY10 | 0.32 | | | | |
| Protin SD-AY10 | 0.32 | 130.0 | 3792.9 | 1 | 55 |
| Protin SD-NY10 | 1.07 | | | | |
| Protin SD-AY10 | 0.32 | 140.0 | 3792.9 | 1 | 60 |
| Protin SD-NY10 | 0.32 | | | | |
| Protin SD-AY10 | 0.32 | 140.0 | 3792.9 | 1 | 60 |
| Protin SD-NY10 | 1.07 | | | | |
| Protin SD-AY10 | 0.32 | 150.0 | 3792.9 | 1 | 65 |
| Protin SD-NY10 | 1.07 | | | | |

TABLE 6

| | Enzyme | Temp. | | Viscosity 1 | Viscosity 1 | Viscosity 2 | Viscosity 1 | |
|---|---|---|---|---|---|---|---|---|
| Enzyme | (g/gallon RE) | (F) | Brix | Temp.(F) | (Before Hold Time) | Temp.(F) | (After Hold Time) | Sensory |
| Control | — | 150.0 | 44.9 | 72.6 | 1317 cp @ 61.1% | 72.4 | 1466 cp @ 61.1% | — |
| Protin SD-AY10 | 0.32 | 130.0 | 45.2 | 72.4 | 134 cp @ 5.6% | 72.1 | 146 cp @ 6.1% | Some bitterness noted, |
| Protin SD-NY10 | 0.32 | | | | | | | but may be acceptable |
| Protin SD-AY10 | 0.32 | 130.0 | 44.9 | 72.8 | 77 cp @ 3.2% | 72.8 | 168 cp @ 7.0% | Some bitterness noted, |
| Protin SD-NY10 | 1.07 | | | | | | | but may be acceptable |
| Protin SD-AY10 | 0.32 | 140.0 | 45 | 72.4 | 168 cp @ 7% | 71.9 | 127 cp @ 5.3% | Unacceptable bitterness |
| Protin SD-NY10 | 0.32 | | | | | | | |
| Protin SD-AY10 | 0.32 | 140.0 | 45.1 | 72.7 | 67 cp @ 2.8% | 72.6 | 199 cp @ 8.3% | Some bitterness noted, |
| Protin SD-NY10 | 1.07 | | | | | | | but may be acceptable |
| Protin SD-AY10 | 0.32 | 150.0 | 45.2 | 72.3 | 211 cp @8.8% | 72.8 | 223 cp @ 99.3% | Most similar to control |
| Protin SD-NY10 | 1.07 | | | | | | | |

### Example 4

Bovine Stock Tested with Mixed Enzymes at Different Temperatures.

Collect 25 gallons of RE veal broth. Pre-weigh broth into marked containers. Pre-weigh all enzymes into well marked containers. Heat broth to target temperature for specified enzyme. First, heat quantity of RE to specific process temperature. Then dose enzyme per chart below. Hold for 15 minutes or 60 minutes. Next, boil to deactivate enzyme (Set 100° C. for 25 minutes for inactivation.) and reduce RE to 45 Brix. Then check viscosity at standard temp (72° F.) and carry out sensory evaluation (1st analysis). Table 7 shows the amounts of RE and enzyme used and Table 8 shows results of Example 4.

TABLE 7

| | Enzyme | Temp. | Time | RE |
|---|---|---|---|---|
| Enzyme | (g/gallon RE) | (F.) | (min) | grams |
| Control | — | 150.0 | 60 | 3792.9 |
| Protin SD-AY10 | 0.5 | 150.0 | 60 | 3792.9 |
| Protin SD-NY10 | 1.5 | | | |
| Protin SD-AY10 | 0.5 | 160.0 | 60 | 3792.9 |
| Protin SD-NY10 | 1.5 | | | |
| Protin SD-AY10 | 0.5 | 170.0 | 60 | 3792.9 |
| Protin SD-NY10 | 1.5 | | | |
| Protin SD-AY10 | 0.5 | 150.0 | 15 | 3792.9 |
| Protin SD-NY10 | 1.5 | | | |
| Protin SD-AY10 | 0.5 | 160.0 | 15 | 3792.9 |
| Protin SD-NY10 | 1.5 | | | |
| Protin SD-AY10 | 0.5 | 170.0 | 15 | 3792.9 |
| Protin SD-NY10 | 1.5 | | | |

TABLE 8

| | Enzyme | Temp. | Time | | Viscosity | | | Viscosity |
|---|---|---|---|---|---|---|---|---|
| Enzyme | (g/gallon RE) | (F) | (min) | Brix | Temp. (F) | Viscosity | Sensory | (%) |
| Control | — | 150.0 | 60 | 45.0 | 72.5 | 1176 cp @ 49.0% | — | 100.0 |
| Protin SD-AY10 | 0.5 | 150.0 | 60 | 45.4 | 77.0 | 197 cp @ 8.2% | Slight bitterness, | 16.8 |
| Protin SD-NY10 | 1.5 | | | | | | but acceptable | |
| Protin SD-AY10 | 0.5 | 160.0 | 60 | 45.4 | 72.3 | 314 cp @ 13.1% | Very close to | 26.7 |
| Protin SD-NY10 | 1.5 | | | | | | control | |
| Protin SD-AY10 | 0.5 | 170.0 | 60 | 45.4 | 77.0 | 331 cp @ 13.8% | Very close to | 28.1 |
| Protin SD-NY10 | 1.5 | | | | | | control | |
| Protin SD-AY10 | 0.5 | 150.0 | 15 | 45.3 | 78.2 | 182 cp @ 7.6% | Very close to | 15.5 |
| Protin SD-NY10 | 1.5 | | | | | | control | |
| Protin SD-AY10 | 0.5 | 160.0 | 15 | 44.9 | 72.2 | 365 cp @ 15.2% | Very close to | 31.0 |
| Protin SD-NY10 | 1.5 | | | | | | control | |
| Protin SD-AY10 | 0.5 | 170.0 | 15 | 45.4 | 74.8 | 523 cp @ 21.8% | Very close to | 44.5 |
| Protin SD-NY10 | 1.5 | | | | | | control | |

### Example 5

Non-Bovine Stock Tested with Mixed Enzymes at 160° F.

Collect 25 gallons of each RE broth (duck, lamb, pork, turkey, chicken). Pre-weigh broth into marked containers. Pre-weigh all enzymes into well marked containers. Heat broth to target temperature for specified enzyme. First, heat quantity of RE to specific process temperature. Then dose enzyme per chart below. Hold for 15 minutes. Next, boil to deactivate enzyme (Set 100° C. for 25 minutes for inactivation) and reduce RE to 45 Brix. Then check viscosity at standard temperature (about 71° F. to 77° F.).

Table 9 below shows results testing of non-bovine stock mixed with Protin SD-AY10 and Protin SD-NY10 at 160° F. and the results compared to a control. As can be seen, using the at least one protease from Bacillus species wherein a reaction condition is 160° F. does not affect the chicken broth in the same manner is it does for bovine, duck, lamb, pork, or turkey leading to an unexpected result for the non-chicken broths tested. For example, in duck broth, the viscosity improved from 3087 Cp to 185 Cp, for lamb it improved from 446 Cp to 48 Cp, for pork it improved from 254 Cp to 31 Cp, and for turkey it improved from 252 Cp to 137 Cp. For similar conditions as shown in Table 8, bovine stock improved from 1176 Cp to 314 Cp. In stark contrast, the chicken stock viscosity improvement was only from 107 Cp to 72 Cp. Accordingly, the use of at least one protease from the Bacillus species wherein a reaction condition is 160° F. led to the unexpected result of significantly improved viscosity while maintaining acceptable sensory taste.

TABLE 9

| | Enzyme | Temp.(F) of | Time in water | | Viscosity | | Viscosity |
|---|---|---|---|---|---|---|---|
| Enzyme | (g/gallon RE) | water bath | bath (min) | Brix | Temp. (F) | Viscosity | (%) |
| Duck | | | | | | | |
| Control | — | 160.0 | 15 | 44.8 | 73.3 | 3087 cp @ 77.2%(30 RPM) | 100.0 |
| Protin SD-AY10 | 0.5 | 160.0 | 15 | 45.1 | 71.3 | 185 cp @ 7.7% | 6.0 |
| Protin SD-NY10 | 1.5 | | | | | | |
| Lamb | | | | | | | |
| Control | — | 160.0 | 15 | 45.0 | 72.0 | 446 cp @ 18.6% | 100.0 |
| Protin SD-AY10 | 0.5 | 160.0 | 15 | 45.0 | 72.5 | 48 cp @ 2.0% | 10.8 |
| Protin SD-NY10 | 1.5 | | | | | | |
| Pork | | | | | | | |
| Control | — | 160.0 | 15 | 44.8 | 72.5 | 254 cp @ 10.6% | 100.0 |
| Protin SD-AY10 | 0.5 | 160.0 | 15 | 44.9 | 70.2 | 31 cp @ 1.3% | 12.2 |
| Protin SD-NY10 | 1.5 | | | | | | |
| Turkey | | | | | | | |
| Control | — | 160.0 | 15 | 44.8 | 72.8 | 252 cp @ 10.5% | 100.0 |
| Protin SD-AY10 | 0.5 | 160.0 | 15 | 44.9 | 71.4 | 137 cp @ 5.7% | 54.4 |
| Protin SD-NY10 | 1.5 | | | | | | |
| Chicken | | | | | | | |
| Control | — | 160.0 | 15 | 32.0 | 73.5 | 106 cp @ 4.3% | 100.0 |
| Protin SD-AY10 | 0.5 | 160.0 | 15 | 32.2 | 72.4 | 72 cp @ 3.0% | 67.9 |
| Protin SD-NY10 | 1.5 | | | | | | |

### Example 6

Bovine Stock Tested with SD-AY10 Only, SD-NY10 Only, and a Combination of Both at Same Temperature.

Collect 25 gallons of RE veal broth. Pre-weigh broth into marked containers. Pre-weigh all enzymes into well marked containers. Heat broth to target temperature for specified enzyme. First, heat quantity of RE to specific process temperature. Then dose enzyme per chart below. Hold for 15 minutes or 60 minutes. Next, boil to deactivate enzyme (Set 100 C for 25 minutes for inactivation.) and reduce RE to 45 Brix. Then check viscosity at standard temp (72° F.) and carry out sensory evaluation (1 st analysis). Table 10 shows results of Example 6, which shows Protin SD-AY10 and Protin SD-NY10 are each fully effective in reducing viscosity if used on its own.

TABLE 10

| | Enzyme | Temp.(F) of | Time in water | | Viscosity | | | Viscosity |
|---|---|---|---|---|---|---|---|---|
| Enzyme | (g/gallon RE) | water bath | bath (min) | Brix | Temp. (F) | Viscosity | Sensory | (%) |
| Control | — | 160.0 | 15 | 45.2 | 74.2 | 1639 cp @ 68.3% | — | 100.0 |
| Protin SD-AY10 | 0.5 | 160.0 | 15 | 45.0 | 71.1 | 245 cp @ 10.2% | Very slight | 14.9 |
| Protin SD-NY10 | 0 | | | | | | bitterness in finish | |
| Protin SD-AY10 | 0 | 160.0 | 15 | 45.1 | 73.1 | 245 cp @ 10.2% | Very slight | 14.9 |
| Protin SD-NY10 | 1.5 | | | | | | bitterness in finish | |
| Protin SD-AY10 | 0.5 | 160.0 | 15 | 45.2 | 71.5 | 204 cp @ 8.5% | Extremely slight | 12.4 |
| Protin SD-NY10 | 1.5 | | | | | | bitterness in finish | |

### Example 7

Animal Stock Mixed with Soluzyme HA 1000, Soluzyme HT 100, and Others.

Collect RE 1st pull from bovine stock, duck stock, lamb stock, pork stock, and turkey stock. For each species, collect enough from just one kettle/RE to do all of the testing as well as to generate 1 concentrate control sample. First, heat quantity of RE to specific process reaction temperature of 160° F. Then dose with appropriate amount of Soluzyme HA 1000, Soluzyme HT 100, or appropriate combination thereof. Also, dose with any combination of at least two of Soluzyme HA 1000, Soluzyme HT 100, SD-AY10, and SD NY10. Hold for 15 minutes. Next, boil to deactivate enzyme (Set 100° C. for 25 minutes for inactivation) and reduce RE to 45 Brix. Then check viscosity at standard temp (72° F.) and carry out sensory evaluation. This will result in an improved viscosity while maintaining acceptable sensory taste for the evaluated stocks.

The exemplary embodiments described and claimed herein is not to be limited in scope by the specific embodiments herein disclosed since these embodiments are intended as illustrations. Any equivalent embodiments are intended to be within the scope of this application. Indeed, various modifications in addition to those shown and described herein will become apparent to those skilled in the art from the foregoing description. Such modifications are also intended to fall within the scope of the appended claims. All publications cited herein are incorporated by reference in their entirety.

To aid the Patent Office and any readers of this application and any resulting patent in interpreting the claims appended hereto, applicants do not intend any of the appended claims or claim elements to invoke 35 U.S.C. 112(f) unless the words “means for” or “step for” are explicitly used in the particular claim.

1. A method for producing bone broth which comprises use of at least one protease wherein a reaction condition is at least 150° F.

2. The method of claim 1 wherein the protease has a relative activity at 120 degrees F. of at least 75%.

3. The method of claim 1, wherein the protease is from the Bacillus species.

4. The method of claim 3, wherein the protease from Bacillus species is at least one of SD-AY10 derived from Bacillus licheniformis, SD-NY10 derived from Bacillus amyloliquefaciens, Soluzyme HA1000, and Soluzyme HT 100.

5. The method of claim 3, wherein the protease from Bacillus species is a thermostable endo protease.

6. The method of claim 1, wherein the protease is a combination of at least two of SD-AY10 derived from Bacillus licheniformis, SD-NY10 derived from Bacillus amyloliquefaciens, Soluzyme HA1000 and Soluzyme HT 100.

7. The method of claim 6 wherein the protease is a combination of SD-AY10 derived from Bacillus lichenformis and SD NY10 derived from Bacillus amyloliquefaciens.

8. The method of claim 1, wherein the bone broth is beef broth.

9. The method of claim 1, wherein the bone broth is a duck broth, lamb broth, pork broth, deer broth, or turkey broth.

10. The method of claim 1, wherein the use of at least one protease reduces the viscosity by about at least 45%.

11. The method of claim 1 wherein the use of at least one protease reduces the viscosity by about at least 50%.

12. The method of claim 1 wherein the use of at least one protease reduces the viscosity by about at least 60%.

13. The method of claim 1 wherein the use of at least one protease reduces the viscosity by about at least 75%.

14. The method of claim 1 wherein the use of at least one protease reduces the viscosity by about at least 90%.

15. The method of claim 10 wherein there is no generation of bitterness or browning of the bone broth.

16. The method of claim 1, wherein the use of at least one protease reduces the viscosity to 500 cp or less at a Brix degree of about 45 when measured by a Brookfield type rotary viscometer at about 72° F. for about one minute at about 50 rpm.

17. The method of claim 16 wherein the use of at least one protease reduces the viscosity to 200 cp or less.

18. The method of claim 16 wherein the viscosity of the bone broth is reduced before a concentration step.

19. The method of claim 1 wherein the bone broth is heated to a reaction temperature of at least 150° F. before the at least one protease is added thereto.

20. The method of claim 19 wherein the bone broth and at least one protease are mixed and then held at the reaction temperature for about not less than 15 minutes.

21. The method of claim 20 wherein a sensory aspect is evaluated after the viscosity is reduced by the at least one protease.
